(19) United States
(12) Patent Application Publication
(10) Pub. No.: US 2016/0124539 A1
(43) Pub. Date: May 5, 2016

(54) INTEGRATED USER INTERFACES HAVING DECORATIVE, TOUCH AND LIGHTING ELEMENTS

(71) Applicant: WHIRLPOOL CORPORATION, Benton Harbor, MI (US)

(72) Inventors: NEOMAR GIACOMINI, BENTON HARBOR, MI (US); BRIAN N. RADFORD, STEVENSVILLE, MI (US)

(73) Assignee: WHIRLPOOL CORPORATION, Benton Harbor, MI (US)

(21) Appl. No.: 14/526,602

(22) Filed: Oct. 29, 2014

(51) Int. Cl. G06F 3/042; G06F 3/041

(52) U.S. Cl. CPC G06F 3/042; G06F 3/0412

(57) ABSTRACT

Integrated user interfaces having decorative, touch and lighting elements are disclosed. An example integrated user interface includes a base formed of an opaque material defining a cavity, the cavity having a light output at the top of the cavity, a panel disposed on the top of the base, a touch sensitive pad disposed within the panel above the light output, a light source disposed on the bottom of the panel at least partially within the cavity, and a material containing phosphor substantially filling the cavity and encompassing at least a portion of the light source.

### BACKGROUND

Many devices have user interfaces that allow a person to operate the device. Example user interface elements include decorative, touch and lighting elements.

### BRIEF DESCRIPTION OF THE DRAWINGS

FIG. 1 is a cross-sectional view of an example integrated user interface constructed in accordance with the teachings of this disclosure.

FIG. 2 illustrates an example manner of assembling the example integrated user interface of FIG. 1.

FIG. 3 is a cross-sectional view of another example integrated user interface constructed in accordance with the teachings of this disclosure.

FIG. 4 illustrates an example manner of assembling the example integrated user interface of FIG. 3.

FIG. 5 is a cross-sectional view of yet another example integrated user interface constructed in accordance with the teachings of this disclosure.

### DETAILED DESCRIPTION

Increasingly, user interfaces include decorative, touch, and lighting elements. Some conventional user interfaces combine a printed circuit board (PCB) having a plurality of light emitting diodes (LEDs), a sheet of plastic light guides, and a decorative film. Light guide sheets often require laser etching, and light blockers are typically required to prevent light bleed between illuminated areas of a user interface. The costs and lead times associated with the design and manufacture of conventional light guide sheets is typically prohibitive. Moreover, the need for a large PCB to position LEDs across a user interface also increases cost and design time.

To overcome at least these problems, integrated user interfaces that combine decorative, touch and lighting elements without the need for a sheet of light guides or a user interface sized PCB are disclosed herein. The integrated user interfaces disclosed herein include a panel having in-molded or deposited decorative, and/or in-molded touch elements that are mounted to a base having cavities filled with, for example, a material containing phosphor and associated light sources. The panel and the base are adhered, affixed, fused, etc. to each other to form an integrated user interface prior to assembly of the integrated user interface to a device or apparatus, such as an appliance, during manufacture. In this way, the panel and the base can be more easily and more accurately aligned.

The example integrated user interfaces disclosed herein may be used as part of any apparatus or device needing or having a user interface with touch, decorative and lighting elements. Example apparatuses and devices include, but are not limited to, a domestic appliance such as a refrigerator, a stove, a range, an oven, a microwave, a dishwasher, a washing machine, a dryer, a freezer, an ice maker, a wine cooler, a beer cooler, a clothes refresher, etc., and/or in any other apparatus, device, etc. having a user interface.

As used herein, an integrated user interface refers to a combination of parts, members, elements, etc. that are joined together and effectively and/or essentially become indivisible, irreversibly one, indecomposable, etc. One of ordinary skill in the art would instantly understand that the integrated user interfaces disclosed herein are not amendable to disassembly back into their constituent parts. For example, once the example panels and bases are joined via, for example, fusing, molding, adhering, etc. into an integrated user interface, it is expected that disassembly would damage at least one of the parts. In stark contrast, conventional user interfaces are composed of elements that are mechanically fit together, snapped together, screwed together, etc. and, thus, can be readily disassembled and reassembled. Even though the parts of a conventional user interface may be considered as a whole when mechanically assembled together, they are not considered as integrated for the purpose of this disclosure and the appended claims.

As used herein, terms such as up, down, top, bottom, side, end, front, back, etc. are used with reference to a currently considered or illustrated orientation. If it is considered with respect to another orientation, it should be understood that such terms must be correspondingly modified.

Reference will now be made in detail to embodiments of this disclosure, examples of which are illustrated in the accompanying drawings. The embodiments are described below by referring to the drawings, wherein like reference numerals refer to like elements. When like reference numerals are shown, corresponding description(s) are not repeated and the interested reader is referred to the previously discussed figure(s) for a description of the like element(s). While the examples disclosed herein are, for ease of illustration, flat integrated user interfaces, it should be understood that integrated user interfaces according to this disclosure may be curved. Moreover, while example arrangements of decorative, touch, phosphor, and light source elements are shown and discussed herein, other arrangements may be used.

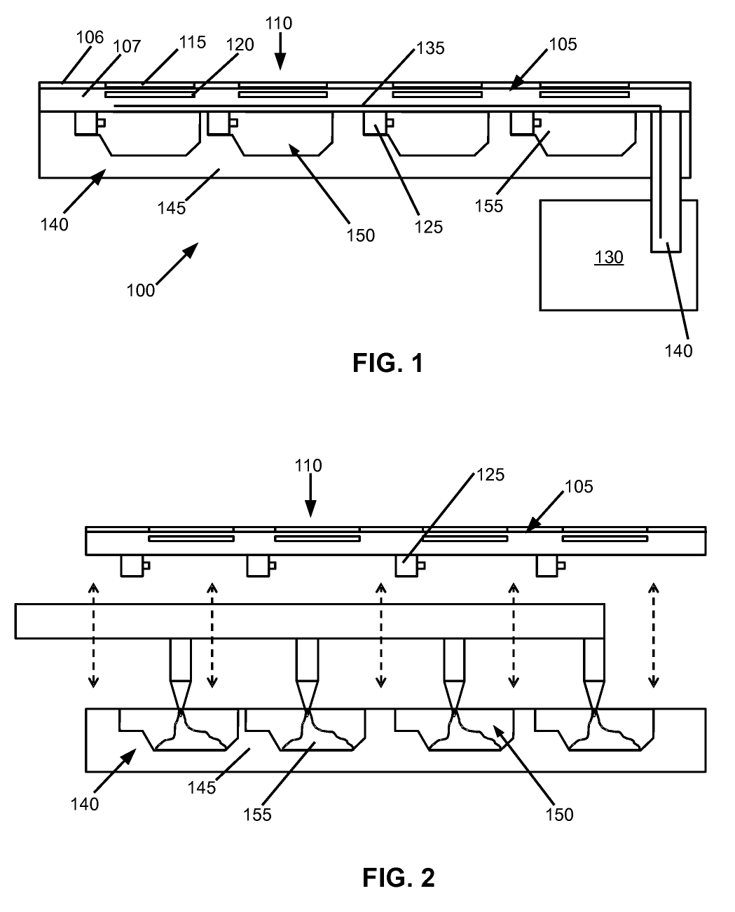

FIG. 1 is a cross-sectional view of an example integrated user interface 100 according to the teachings of this disclosure. The example integrated user interface 100 includes a fascia or front panel 105 formed of a decorative material, such as black plastic, painted plastic, etc. The top of the fascia panel 105 (in the orientation of FIG. 1) is the portion of the user interface 100 seen by and used by a user to control a device associated with the user interface 100.

As shown in FIG. 1, the integrated user interface 100 includes a plurality of illuminated, decorative touch areas, one of which is designated with reference numeral 110. In the example of FIG. 1, each of the areas 110 has an associated, at least partially transparent label or icon 115, and a touch pad 120. However, an area 110 need not include both a touch pad 120 and a label or icon 115. For example, an area 110 may be a display-only area, or an area 100 may be an unlit touch area.

To provide lighting for some or all of the areas 110, the panel 105 includes a plurality of LEDs (one of which is designated at reference numeral 125) for respective ones of the areas 110. The example LEDs 125 of FIG. 1 are side-fire ultra-violet (UV) or phosphor-less LEDs that emit invisible light.

To electrically couple the touch pads 120 and the LEDs 125 to a PCB 130 controlling a device such as an appliance, the example panel 105 includes one or more electrical traces 135. The electrical traces 135 are electrically coupled to the PCB 130 via a cable 140, such as a flat printed circuit cable, a flat ribbon cable, a flexible flat cable, a flat flex cable, etc.

In some examples, the panel 105 is formed by applying a decorative film 106 containing or having the label or icons 115 to a plastic substrate 107 containing the touch pads 120 and the traces 135, and having the LEDs 125 mounted thereon. In some examples, portions of the decorative film 106 outside the label or icons 125 are opaque to reduce light bleed. The touch pads 120 and the traces 135 may be, for example, in-molded in the plastic substrate 107. Alternatively or additionally, the decorative film 106 may instead be a layer of paint or colored plastic applied to or deposited on the plastic substrate 107.

To illuminate the areas 110, the example integrated user interface 100 includes a base 140. The example base 140 is formed of an opaque material 145 having cavities (one of which is designated at reference numeral 150) defined therein. In the example of FIG. 1, the cavities 150 are filled with a material 155 containing phosphor that at least partially encompasses the LEDs 125. The phosphor material 155 changes invisible light emitted by the LEDs 125 into visible light, diffuses the visible light, and directs the diffused light upward toward the areas 110. Because the cavities 150 are surrounded by the opaque material 145, light bleed between the areas 110 from different cavities 150 is reduced.

As shown in FIG. 2, the integrated user interface 100 can be assembled by filling the cavities 150 with the phosphor material 155 in, for example, a paste-like state and then bringing the panel 105 into contact with the base 140. In some examples, the phosphor material 155, when cured or dried using, for example, heat or air, adheres, affixes, fuses, etc. the panel 105 and the base 140 into the integrated user interface 100. In the example of FIG. 2, when the panel 105 and the base 140 are brought into contact, the LEDs 125 become at least partially embedded in the phosphor material 155. Alternatively or additionally, other methods and/or materials, such as glue or heat, may be used to integrate the panel 105 and the base 140.

Returning to FIG. 1, the base 140 may be formed using injection molding with the opaque material 145 to form the cavities 150. In some examples, instead of using a paste-like phosphor material 155, as shown in FIG. 2, the cavities 150 may instead be filled with plastic having phosphor-based coloring via an additional injection molding step.

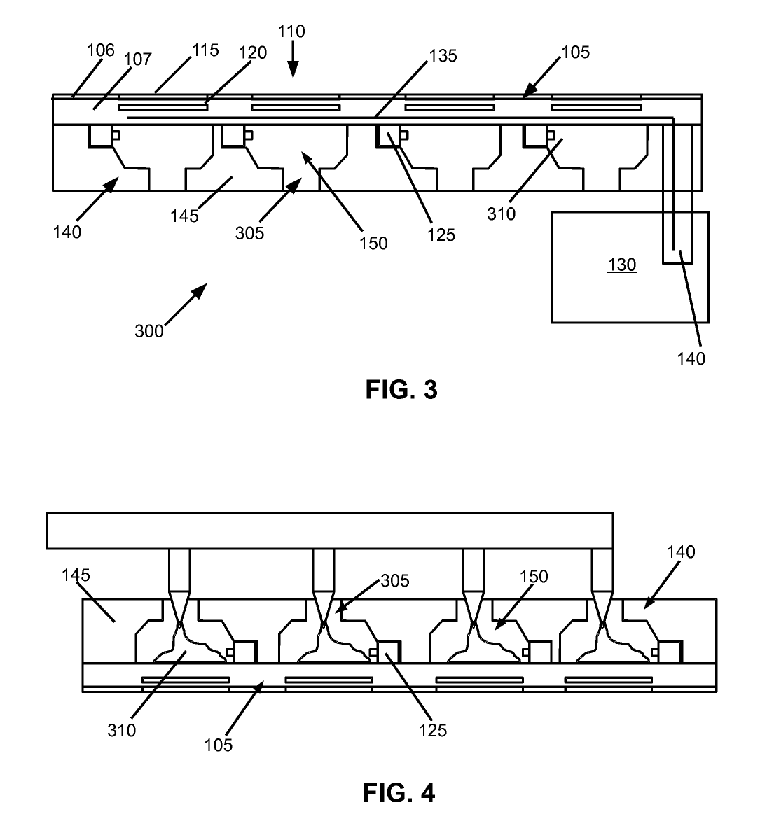

FIG. 3 is a cross-sectional view of another example integrated user interface 300. In contrast to FIG. 1, in the example of FIG. 3 the cavities 150 have a respective passageway 305 that allows the cavity 150 to be filed or injected with a material 310 containing phosphor after the panel 105 and the base 140 are brought into contact, as shown in FIG. 4. The phosphor material 310 used to fill the cavities 150 at least partially encompasses the LEDs 125, and changes invisible light emitted by the LEDs 125 into visible light, diffuses the visible light, and directs the diffused light upward through the areas 110. Because the cavities 150 are surrounded by the opaque material 145, light bleed between adjacent areas 110 and/or the cavities 150 is reduced. In some examples, the phosphor material 310 is the same type as the phosphor material 155. In some examples, instead of using a paste-like phosphor material 310 as shown in FIG. 3, the cavities 150 may instead be filled with plastic having phosphor-based coloring via injection molding.

In some examples, the injected phosphor material 310, when cured or dried using, for example, heat or air, adheres, affixes, fuses, etc. the panel 105 and the base 140 into the integrated user interface 300. Alternatively or additionally, other methods and/or materials, such as glue or heat, may be used to integrate the panel 105 and the base 140.

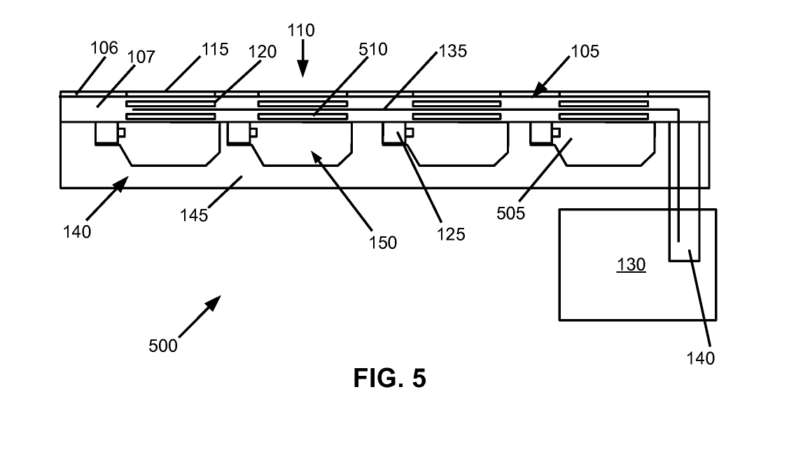

FIG. 5 is a cross-sectional view of yet another example integrated user interface 500. In contrast to FIG. 1, in the example of FIG. 5 the cavities 150 are filed with a transparent material 505 rather than a material containing phosphor. The transparent material 505 used to fill the cavities 150 at least partially encompasses the LEDs 125, and directs the invisible light emitted by the LEDs 125 upward through the areas 110. Because the cavities 150 are surrounded by the opaque material 145, light bleed between adjacent areas 110 and/or the cavities 150 is reduced.

To convert the invisible light into visible light, the example integrated user interface 500 of FIG. 5 includes a plurality of areas formed of a material containing phosphor, one of which is designated at reference numeral 510. The phosphor areas 510 may, for example, be in-molded in the panel 105. In some examples, the transparent material 505 is formed via injection molding. Any method(s) and/or material(s), such as glue or heat, may be used to integrate the panel 105 and the base 140.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. An integrated user interface assembly, comprising:
a base formed of an opaque material defining a cavity, the cavity having a light output at the top of the cavity;
a panel disposed on the top of the base;
a touch sensitive pad disposed within the panel above the light output;
a light source disposed on the bottom of the panel at least partially within the cavity; and
a material containing phosphor substantially filling the cavity and encompassing at least a portion of the light source.

2. An integrated user interface assembly as defined in claim 1, wherein the phosphor material adheres the base to the panel.

3. An integrated user interface assembly as defined in claim 1, wherein the base is fused to the panel.

4. An integrated user interface assembly as defined in claim 1, further comprising a decorative element on the top of the panel above the light output.

5. An integrated user interface assembly as defined in claim 1, wherein the cavity is substantially filed with the phosphor material before the base and the panel are brought in contact.

6. An integrated user interface assembly as defined in claim 1, wherein the base further comprises a passageway to enable the cavity to be substantially filed with the phosphor material after the base and the panel are brought in contact.

7. An integrated user interface assembly as defined in claim 1, wherein the phosphor material comprises a plastic and phosphor coloring.

8. An integrated user interface assembly as defined in claim 7, wherein the base and the cavity are formed in a first injection molding, and the plastic and phosphor coloring are formed in the cavity in a second injection molding.

9. An integrated user interface assembly as defined in claim 1, further comprising:
a circuit board trace disposed within the panel; and
a cable to electrically couple the circuit board trace to a printed circuit board separate from the user interface.

10. An integrated user interface assembly as defined in claim 9, wherein the touch sensitive pad comprises at least a portion of the trace.

11. An integrated user interface assembly as defined in claim 1, wherein the light source comprises a phosphor-less light emitting diode.

12. An integrated user interface assembly, comprising:
a base formed of an opaque material defining a cavity, the cavity comprising a transparent material and having a light output at the top of the cavity;
a panel disposed on top of the base;
a material containing phosphor disposed within the panel above the light output;
a touch sensitive pad disposed within the panel above the light output; and
a light source disposed on a bottom of the panel at least partially within the cavity.

13. An integrated user interface assembly as defined in claim 12, wherein the base is fused to the panel.

14. An integrated user interface assembly as defined in claim 12, further comprising a decorative element on the top of the panel above the light output.

15. An integrated user interface assembly as defined in claim 12, wherein the base and the cavity are formed of the opaque material in a first injection molding, and the transparent material is formed in the cavity in a second injection molding.

16. An integrated user interface assembly as defined in claim 12, wherein the phosphor material comprises a plastic and phosphor coloring material in-molded into the panel.

17. A method of forming an integrated user interface, the method comprising:
forming a plastic substrate having an embedded flexible circuit board trace and a light source affixed to the bottom of the plastic element;
forming a decorative element on the plastic substrate;
forming a base from an opaque material defining a cavity, the cavity having a light output at the top of the cavity;
substantially filling the cavity with a material containing phosphor; and
bringing the bottom of the plastic substrate into contact with the top of the base to adhere the base to the plastic substrate.

18. A method as defined in claim 17, wherein the cavity is substantially filed with the phosphor material prior to the plastic substrate and base being brought into contact.

19. A method as defined in claim 17, wherein forming the decorative element on the plastic structure comprises at least one of applying a film to the plastic substrate or depositing paint on the plastic substrate.
